(19) United States
(12) Patent Application Publication
(10) Pub. No.: US 2021/0287239 A1
(43) Pub. Date: Sep. 16, 2021

(54) CONSUMER PRODUCT TRIAL KIT

(71) Applicant: The Gillette Company LLC, Boston, MA (US)

(72) Inventors: Leigh Knight, Reading (GB); Emma-Jane O'Leary, Bramley (GB); Susan Clare Robinson, Windsor (GB); Trevor John Whelan, Thatcham (GB)

(21) Appl. No.: 17/198,824

(22) Filed: Mar. 11, 2021

Related U.S. Application Data
(60) Provisional application No. 62/988,461, filed on Mar. 12, 2020.

(51) Int. Cl. G06Q 30/02; B26B 21/40; B65D 85/62

(52) U.S. Cl. CPC G06Q 30/0207; B65D 2501/24872; B65D 85/62; B26B 21/4012

(57) ABSTRACT

A consumer product trial kit is provided comprising a razor handle, a first razor cartridge configured to couple with the razor handle and comprising a first skin engaging feature, and a second razor cartridge configured to couple with the razor handle and comprising a second skin engaging feature. A first identifying feature is associated with the first razor cartridge and a second identifying feature is associated with the second razor cartridge. The second skin engaging feature and the associated second identifying feature may be different than the first skin engaging feature and the associated first identifying feature, respectively. A selection recorder is configured to allow selection of either the first razor cartridge or the second razor cartridge.

### FIELD OF THE INVENTION

The invention generally relates to consumer product trial kits and, more particularly, to consumer product trial kits comprising a razor handle and two or more razor cartridges, each of a different design.

### BACKGROUND OF THE INVENTION

Traditionally, razor handles and razor cartridges were packaged and sold with one razor handle combined with one or a plurality of razor cartridges. When a plurality of razor cartridges were sold with the razor handle, those razor cartridges were of the same design. If a consumer wanted to try more than one cartridge design to determine which one she/he preferred, the consumer had to buy two or more packages of razor handles and razor cartridges. The purchase of shaving products in this manner can be very costly and time consuming. Accordingly, a consumer may be stuck with several shaving razor cartridges they do not even like. Consumers may also feel obligated to keep shaving with the same shaving razor cartridge design even if they do not enjoy the experience because they have already spent their money on them.

When consumers visit a store to shop for shaving razors or replacement shaving razor cartridges it is difficult to determine which of the vast offerings of shaving razors and shaving razor cartridges they should buy to best meet their needs. The space available at the store shelf to advertise and communicate different advantages to the consumer is limited, crowded and confusing. Store shelves tend to stock high numbers of different razor handles and razor cartridge designs. Accordingly, it is hard for a typical consumer to navigate the shelf and to make an informed decision, especially younger consumers that may be new to the shaving category. The limitation in space on the shelf to communicate information about the differences in performance of the razor handles and razor cartridges being offered magnifies this problem further and often leads to confusion on which product should be purchased.

Another problem consumers encounter is they cannot recall the exact shaving razor cartridge they last purchased or enjoyed the most. Consumers typically throw away all of the packaging for the shaving razor once they begin shaving. It may take a consumer a month or longer to use up the four shaving razor cartridges that typically come in a single product offering. Accordingly, by the time they need to purchase more shaving razor cartridges they do not remember the exact shaving razor they last purchased. This can be even more problematic with the abundance of private label store brands available at the shelf that try to mimic or copy the color and design of branded shaving razors. Thus, it would be advantageous to provide for a personal product trial kit that addresses one or more of these issues.

### SUMMARY OF THE INVENTION

In accordance with a first aspect of the present disclosure, a consumer product trial kit is provided comprising: a razor handle; a first razor cartridge configured to be coupled with the razor handle and comprising a first skin engaging feature; a first identifying feature associated with the first razor cartridge; a second razor cartridge configured to be coupled with the razor handle and comprising a second skin engaging feature; a second identifying feature associated with the second razor cartridge; and a selection recorder. The second skin engaging feature and the associated second identifying feature may be different than the first skin engaging feature and the associated first identifying feature, respectively. The selection recorder may be configured to allow selection of either the first razor cartridge or the second razor cartridge.

The associated first identifying feature may comprise a first distinguishable feature formed as part of the first razor cartridge and the associated second identifying feature may comprise a second distinguishable feature formed as part of the second razor cartridge. The first distinguishable feature may be defined by the first skin engaging feature of the first razor cartridge having a first distinguishable color and the second distinguishable feature may be defined by the second skin engaging feature of the second razor cartridge having a second distinguishable color.

The associated first identifying feature may comprise a first coupon associated with the first razor cartridge and the associated second identifying feature may comprise a second coupon associated with the second razor cartridge. The first and second coupons may also define the selection recorder.

The consumer product trial kit may further comprise a tray having a first compartment for receiving the first razor cartridge and a second compartment for receiving the second razor cartridge. The first coupon may be located in the first compartment with the first razor cartridge and the second coupon may be located in the second compartment with the second razor cartridge.

The first identifying feature may comprise at least one of a first graphic, a first symbol, a first letter or a first number integral with or coupled to the first razor cartridge and the second identifying feature may comprise at least one of a second graphic, a second symbol, a second letter or a second number integral with or coupled to the second razor cartridge.

The associated first identifying feature may comprise a first distinguishable feature removably attached to the first razor cartridge and the associated second identifying feature may comprise a second distinguishable feature removably attached to the second razor cartridge. The first removable feature may comprise a first visually distinguishable label and the second removable feature may comprise a second visually distinguishable label. The selection recorder may comprise at least one selection window for receiving one of the first or the second label to record the selection of either the first or the second razor cartridge.

The associated first identifying feature may comprise a first distinguishable feature located on the tray proximate to the first razor cartridge and the associated second identifying feature may comprise a second distinguishable feature located on the tray proximate to the second razor cartridge.

The first distinguishable feature may comprise at least one of a first graphic, a first symbol, a first letter or a first number integral with or coupled to the tray and the second distinguishable feature may comprise at least one of a second graphic, a second symbol, a second letter or a second number integral with or coupled to the tray.

The first distinguishable feature may comprise a first distinguishable label removably attached to the tray proximate to the first razor cartridge and the second distinguishable feature may comprise a second distinguishable label removably attached to the tray proximate to the second razor cartridge. The selection recorder may comprise at least one selection window for receiving one of the first or the second label to record the selection of either the first or the second razor cartridge.

The selection recorder may comprise a tag list including a selection window corresponding to each of the first and second razor cartridges. A user can indicate a selected one of the first cartridge or the second cartridge by marking the corresponding window in the tag list for the selected one cartridge, punching the corresponding window in the tag list for the selected one cartridge or pasting a label in the corresponding window in the tag list for the selected one cartridge.

The selection recorder may comprise a selection window for receiving a label identifying a selected one of the first razor cartridge or the second razor cartridge.

The consumer product trial kit may further comprise an instruction list to provide instructions for sampling the razor cartridges.

In accordance with a second aspect of the disclosure, a consumer product trial kit is provided comprising: a razor handle; a first razor cartridge configured to be coupled with the razor handle and comprising a first skin engaging feature; a first identifying feature associated with the first razor cartridge; a second razor cartridge configured to be coupled with the razor handle and comprising a second skin engaging feature; a second identifying feature associated with the second razor cartridge; a tray; and a selection recorder. The second skin engaging feature and the associated second identifying feature may be different than the first skin engaging feature and the associated first identifying feature, respectively. The first razor cartridge and the second razor cartridge may be positioned within the tray. The selection recorder may be configured to allow selection of either the first razor cartridge or the second razor cartridge.

### BRIEF DESCRIPTION OF THE DRAWINGS

While the specification concludes with claims particularly pointing out and distinctly claiming the subject matter which is regarded as forming the present invention, it is believed that the invention will be better understood from the following description which is taken in conjunction with the accompanying drawings in which like designations are used to designate substantially identical elements, and in which:

FIG. 1 is a view of a consumer product trial kit formed in accordance with a first embodiment of the present disclosure;

FIG. 2 is a view of a razor handle, a plurality of razor cartridges and a tray for receiving the razor cartridges of the embodiment illustrated in FIG. 1;

FIG. 3 is a view of a consumer product trial kit formed in accordance with a second embodiment of the present disclosure;

FIG. 4 is a view of a plurality of razor cartridges and a storage tray and schematically illustrates a shaving handle, a container and a selection recorder of a consumer product trial kit formed in accordance with a third embodiment of the present disclosure;

FIG. 5 is a view of a plurality of razor cartridges and a storage tray and schematically illustrates a shaving handle, a container and a selection recorder of a consumer product trial kit formed in accordance with a fourth embodiment of the present disclosure;

FIG. 6 is a schematic view of a plurality of razor cartridges, a shaving handle, a storage tray and a container of a consumer product trial kit formed in accordance with a fifth embodiment of the present disclosure;

FIG. 7 is a view of first, second and third coupons of the embodiment of FIG. 6; and

FIG. 8 is a view of a consumer product trial kit formed in accordance with a sixth embodiment of the present disclosure.

### DETAILED DESCRIPTION OF THE INVENTION

In accordance with the present disclosure, a consumer product trial kit 10 is provided having a razor handle 20 and two or more different razor cartridges 30, each of which is adapted to be separately coupled to the razor handle 20 for use during separate shaving trials by a consumer. Each of the razor cartridges 30 has one or more skin engaging features which may be different from one or more skin engaging features on the other cartridges, which may provide different shaving experiences for the consumer. Hence, a consumer can use each of the separate razor cartridges 30 during separate shaving trials to determine which cartridge 30 the consumer prefers.

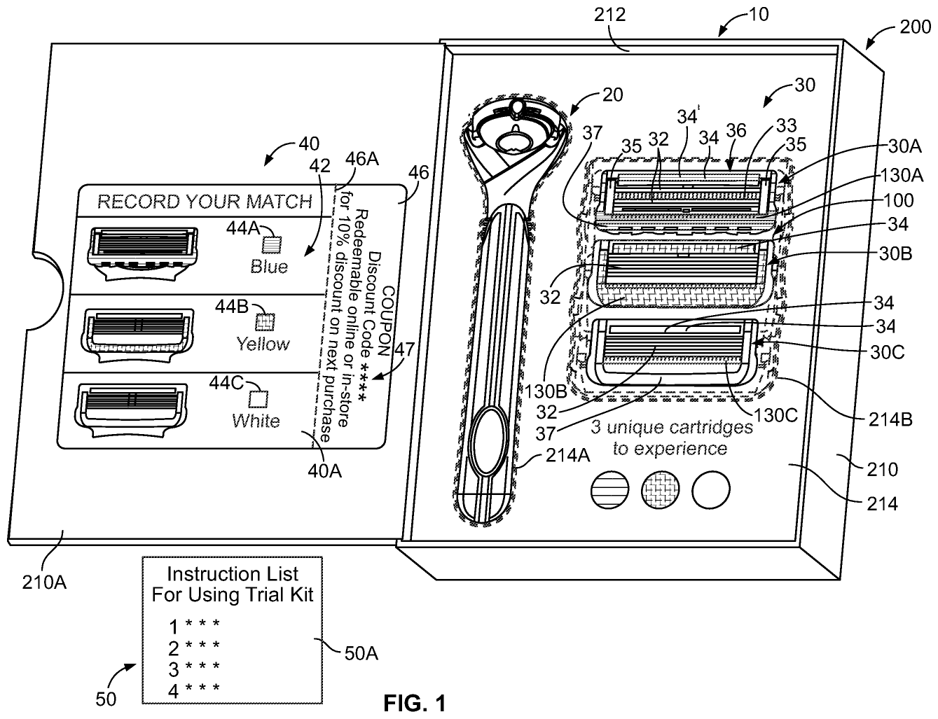

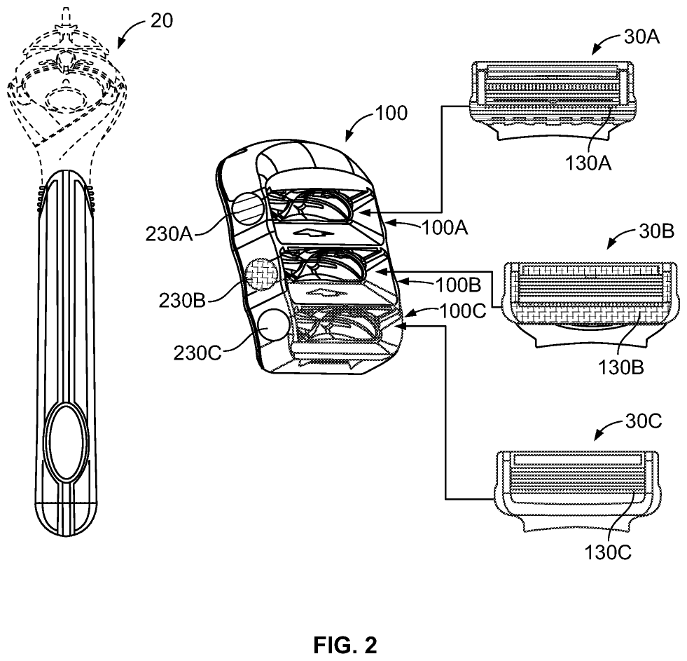

In accordance with a first embodiment of the present disclosure illustrated in FIGS. 1 and 2, the consumer product trial kit 10 comprises a first razor cartridge 30A, a second razor cartridge 30B and a third razor cartridge 30C, wherein each of the first, second and third razor cartridges 30A-30C has one or more skin engaging features which are different from skin engaging features on the other two cartridges. Skin engaging features may comprise blades 32, a guard structure 130A-130C, a cap 34, clips 35 that retain the blades 32 in a cartridge housing 36, interblade elements such as a comb guard between the blades 32 and/or lubrication surfaces that may be adjacent the guard structure 130A-130C or part of the cap 34. The skin engaging features of each razor cartridge 30A-30C may have a different color. The guard structure 130A-130C and the cap 34 may form an integral part of the cartridge housing 36.

In the embodiment illustrated in FIGS. 1 and 2, the first razor cartridge 30A may have a first skin engaging feature comprising a comb guard 33 between the blades 32, a second skin engaging feature comprising a guard structure 130A in front of the blades 32, a third skin engaging feature comprising a lubrication bar 37 in front of the guard structure 130A, and a fourth skin engaging feature comprising a cap 34 with a lubrication strip 34′, wherein the first cartridge 30A comprises two blades 32, which define a fifth skin engaging feature. One or more of the first, second, third, fourth and fifth skin engaging features on the first razor cartridge 30A may be of a first distinguishing color, such as blue in the illustrated embodiment. The second razor cartridge 30B may have a first skin engaging feature comprising an elastomeric guard structure 130B in front of the blades 32, which is larger in size than the guard structure 130A on the first cartridge housing 30A, and a second skin engaging feature comprising a cap 34 behind the blades 32 without a lubrication strip, wherein the second cartridge 30B comprises five blades 32, which define a third skin engaging feature. One or more of the first, second and third skin engaging features on the second razor cartridge 30B may be of a second distinguishing color, such as yellow in the illustrated embodiment. The third razor cartridge 30C may have a first skin engaging feature comprising a guard structure 130C in front of the blades 32, a second skin engaging feature comprising a lubrication bar 37 in front of the guard structure 130C and a third skin engaging feature comprising a cap 34 with a lubrication strip 34′, wherein the third cartridge 30C comprises five blades 32, which define a fourth skin engaging feature. One or more of the first, second, third and fourth skin engaging features on the third razor cartridge 30C may be of a third distinguishing color, such as white in the illustrated embodiment. Each of the first, second and third cartridges 30A-30C may have at least one skin engaging feature that differs from the skin engaging feature or features on each of the other two razor cartridges. For example, the first cartridge 30A comprises the comb guard 33 between the blades 32 which differs from the skin engaging features on the second and third cartridges 30B and 30C since the second and third cartridges lack a comb guard between the blades. Further, the second razor cartridge 30B comprises an elastomeric guard structure 130B, which is different from the guard structures 130A and 130C provided on the first and third razor cartridges 30A and 30C. The third razor cartridge 30C has five blades 32 which differs from the number of blades forming part of the first cartridge 30A and includes a lubrication bar 37 and a cap 34 with a lubrication strip 34′ not provided on the second cartridge 30B.

The consumer product trial kit 10 may further comprise a tray 100 for releasably holding and/or storing the first, second and third razor cartridges 30A-30C. The tray 100 may be formed from a polymeric, paperboard or cardboard material or other similar material. The consumer product trial kit 10 may still further comprise a container, such as a box 200, for holding and displaying the handle 20 and the tray 100 containing the razor cartridges 30A-30C. The box 200 may comprise a base 210 provided with a cavity 212 for receiving an insert 214 including a first recess 214A for receiving the handle 20 and a second recess 214B for receiving the tray 100. The box 200 may further comprise a cover 210A pivotably coupled to the base 210, wherein the cover 210A is shown in an “open” position in FIG. 1. The cover 210A may be moved to a closed position to engage the base 210 and close and seal the box 200.

To allow the consumer to easily identify and differentiate each of the razor cartridges 30A-30C, one or more identifying features is associated with each razor cartridge 30A-30C. Hence, each razor cartridge 30A-30C has an identifying feature associated with it which is different from a corresponding identifying feature associated with the other cartridges.

In the embodiment illustrated in FIG. 1, each of the first, second and third razor cartridges 30A-30C comprises an identifying feature defined by a distinguishable feature formed with the razor cartridge. More specifically, the first razor cartridge 30A comprises a first distinguishable feature defined by a guard structure 130A formed of a first color, such as blue; the second razor cartridge 30B comprises a second distinguishable feature defined by a guard structure 130B formed of a second color, such as yellow; and the third razor cartridge 30C comprises a third distinguishable feature defined by a guard structure 130C formed of a third color, such as white. Hence, the guard structures 130A-130C having different colors allow a consumer to easily distinguish the razor cartridges 30A-30C from one another. Each of the guard structures 130A-130C defines a skin engaging feature of its corresponding razor cartridge 30A-30C. It is also contemplated that one or more other structures of each cartridge may define a distinguishable feature for that cartridge. For example, one or more blades 32, clips 35, interblade elements, lubrication surfaces, and/or a cap 34 of a cartridge may define a distinguishable feature for the cartridge by having a color that differs from the color(s) of corresponding elements of the other cartridges.

Each of the razor cartridges 30A-30C in the embodiment illustrated in FIGS. 1 and 2 further comprises a second identifying feature comprising a label that may be removably secured to the tray 100 via adhesive adjacent a compartment in the tray 100 where the razor cartridge 30A-30C is housed. For example, a first label 230A may be secured to the tray 100 adjacent to a first compartment 100A in the tray 100 where the first cartridge 30A is positioned, a second label 230B may be secured to the tray 100 adjacent to a second compartment 100B in the tray 100 where the second cartridge 30B is positioned, and a third label 230C may be secured to the tray 100 adjacent to a third compartment 100C in the tray 100 where the third cartridge 30C is positioned. The first, second and third labels 230A-230C preferably are colored the same as the distinguishable feature of their corresponding cartridge 30A-30C. Hence, the first label 230A may be blue, the second label 230B may be yellow, and the third label 230C may be white.

The consumer product trial kit 10 further comprises a selection recorder 40, which allows a consumer to select which of the razor cartridges 30A-30C she/he prefers. After the consumer makes her/his selection, the selection recorder 40 may be provided to the manufacturer to order additional ones of the selected razor cartridge. The selection recorder 40 may be mailed to the manufacturer or a photo of the selection recorder 40 may be made, which photo may be sent to the manufacturer via email, text or mail.

In the embodiment illustrated in FIG. 1, the selection recorder 40 comprises a card 40A formed from paper, paperboard, cardboard or the like and may be releasably attached to the cover 210A of the box 200 via adhesive. The card 40A may also be attached to the cover 210A or other portion of the box 200 via a perforation line for easy detachment or may be a separate card 40A that is loosely placed within the box 200. The selection recorder 40 comprises a tag list 42 including a selection window 44A-44C corresponding to each of the first, second and third razor cartridges 30A-30C, wherein an image of the first, second and third razor cartridges 30A-30C is also provided on the card 40A adjacent to the corresponding selection window. A consumer can indicate a selected one of the first, second or third cartridge 30A-30C by marking the corresponding window 44A-44C in the tag list 42 for the selected one cartridge, punching the corresponding window 44A-44C in the tag list 42 for the selected one cartridge or pasting the corresponding label 230A-230C in the corresponding window 44A-44C in the tag list 42 for the selected one cartridge.

The consumer product trial kit 10 may still further comprise an instruction list 50 comprising a card 50A formed from paper, paperboard, cardboard or the like that may be attached to any portion of the box 200 or loosely placed within the box 200. The instruction list 50 may provide instructions to the consumer regarding best practices for sampling/using the razor cartridges 30A-30C to allow for consistent trial results. For example, the list may include an instruction to use each razor cartridge 30A-30C in the same environment, e.g., each razor cartridge 30A-30C should be used either while shaving at a sink or in the shower, and may also provide an instruction that each razor cartridge 30A-30C should be used for an equivalent number of shaves before the user makes a decision regarding the razor she/he prefers most. Other instructions for sampling/using the razor cartridges 30A-30C may also be provided on the list 50. It is also contemplated that any one of the components of the trial kit 10 may be personalized with a consumer's name. For example, a consumer's name may be included on the box 200, on the selection recorder 40, on the instruction list 50 or on the razor cartridges 30A-30C.

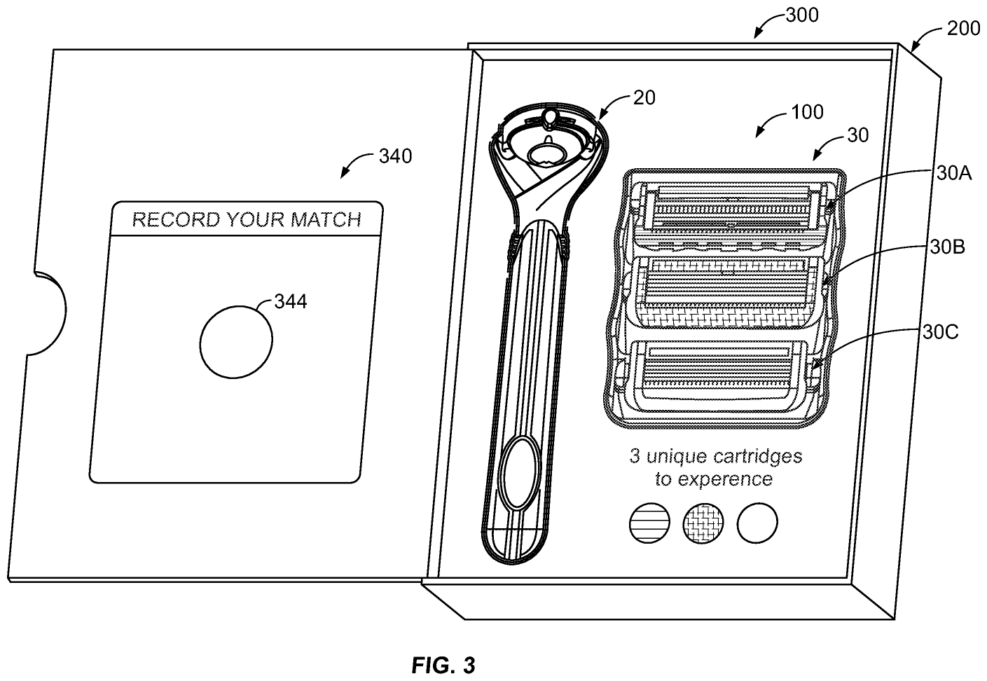

A consumer product trial kit 300 constructed in accordance with a second embodiment of the present disclosure is illustrated in FIG. 3. In this embodiment, the razor handle 20, the first, second and third razor cartridges 30A-30C and the tray 100 are the same as the corresponding elements in the embodiment illustrated in FIG. 1. However, the selection recorder 340 in FIG. 3 comprises only a single selection window 344, rather than three selection windows as provided in the embodiment of FIG. 1. A consumer can indicate a selected one of the first, second or third cartridge 30A-30C by securing or pasting a corresponding label 230A-230C for the selected one cartridge in the selection window 344.

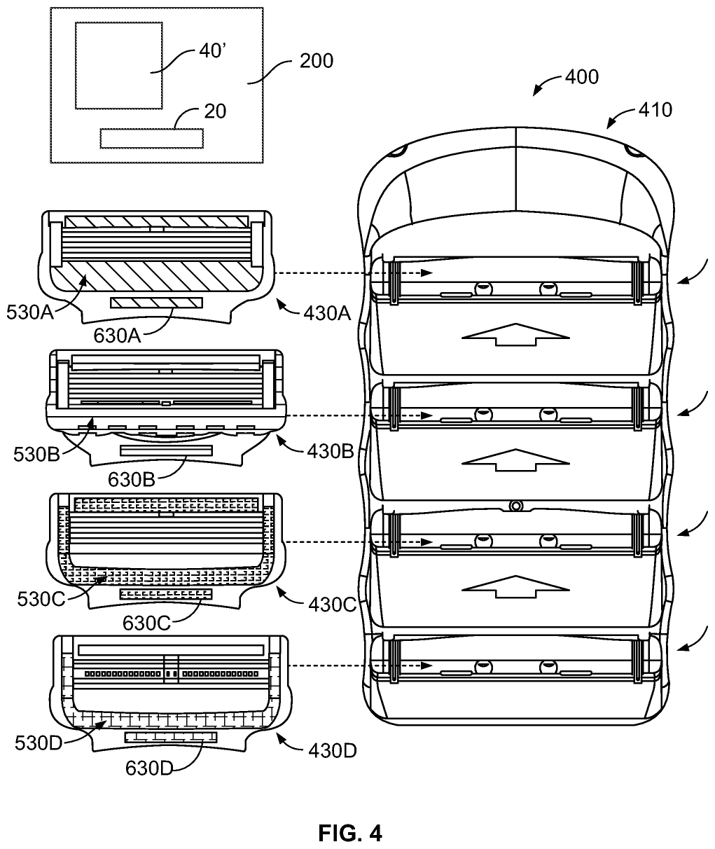

A consumer product trial kit 400 constructed in accordance with a third embodiment of the present disclosure is illustrated in FIG. 4. The consumer product trial kit 400 preferably includes a razor handle 20 and may comprise a container 200 and a selection recorder 40′, which are schematically illustrated in FIG. 4 and formed in the same manner as the handle 20, container 200 and selection recorder 40 of the embodiment illustrated in FIG. 1, wherein the selection recorder 40′ includes four selection windows. The trial kit 400 further comprises a first razor cartridge 430A, a second razor cartridge 430B, a third razor cartridge 430C, and a fourth razor cartridge 430D, wherein each of the first, second, third and fourth razor cartridges 430A-430D has one or more skin engaging features which are different from one or more skin engaging features on the other three cartridges.

The consumer product trial kit 400 may further comprise a tray 410 for releasably holding the first, second, third and fourth cartridges 430A-430D.

To allow the consumer to easily identify and differentiate each of the razor cartridges 430A-430D, each razor cartridge 430A-430D comprises one or more identifying features associated with the razor cartridge. In the embodiment illustrated in FIG. 4, each of the first, second, third and fourth razor cartridges 430A-430D comprises an identifying feature defined by a distinguishable feature integrally formed with the razor cartridge. More specifically, the first razor cartridge 430A comprises a first distinguishable feature defined by a guard structure 530A formed of a first color, such as green; the second razor cartridge 430B comprises a second distinguishable feature defined by a guard structure 530B formed of a second color, such as blue; the third razor cartridge 430C comprises a third distinguishable feature defined by a guard structure 530C formed of a third color, such as red; and the fourth razor cartridge 430D comprises a fourth distinguishable feature defined by a guard structure 530D formed of a fourth color, such as yellow. Each of the guard structures 530A-530D defines a skin engaging feature of its corresponding razor cartridge 430A-430D. Hence, the guard structures 530A-530D having different colors allow a consumer to easily distinguish the razor cartridges 430A-430D from one another.

Each of the razor cartridges 430A-430D in the embodiment illustrated in FIG. 4 further comprises an additional identifying feature comprising a distinguishable feature removably attached to the cartridge, such as a visually distinguishable label attached via adhesive to the cartridge. For example, a first label 630A may be secured to the first cartridge 430A, a second label 630B may be secured to the second cartridge 430B, a third label 630C may be secured to the third cartridge 430C, and a fourth label 630D may be secured to the fourth cartridge 430D. Each of the labels 630A-630D has a rectangular shape but may have any other shape. The first, second, third and fourth labels 630A-630D are preferably of the same color as the color of the distinguishable feature of their corresponding cartridge 430A-430D. Hence, the first label 630A may be green, the second label 630B may be blue, the third label 630C may be red and the fourth label 630D may be yellow.

While not illustrated in FIG. 4, it is also contemplated that each of the razor cartridges 430A-430D may still further include yet another identifying feature comprising a label, similar to one of the labels 230A-230C, that may be removably secured to the tray 410 via adhesive adjacent a compartment in the tray 410 where the cartridge 430A-430D is housed.

The selection recorder of the trial kit 400 may comprise a tag list including a selection window corresponding to each of the first, second, third and fourth razor cartridges 430A-430D. A consumer can indicate a selected one of the first, second, third or fourth cartridges 430A-430D by adhering the corresponding label 630A-630D removed from the selected cartridge or a corresponding label from the tray 410 in the corresponding window in the tag list for the selected cartridge.

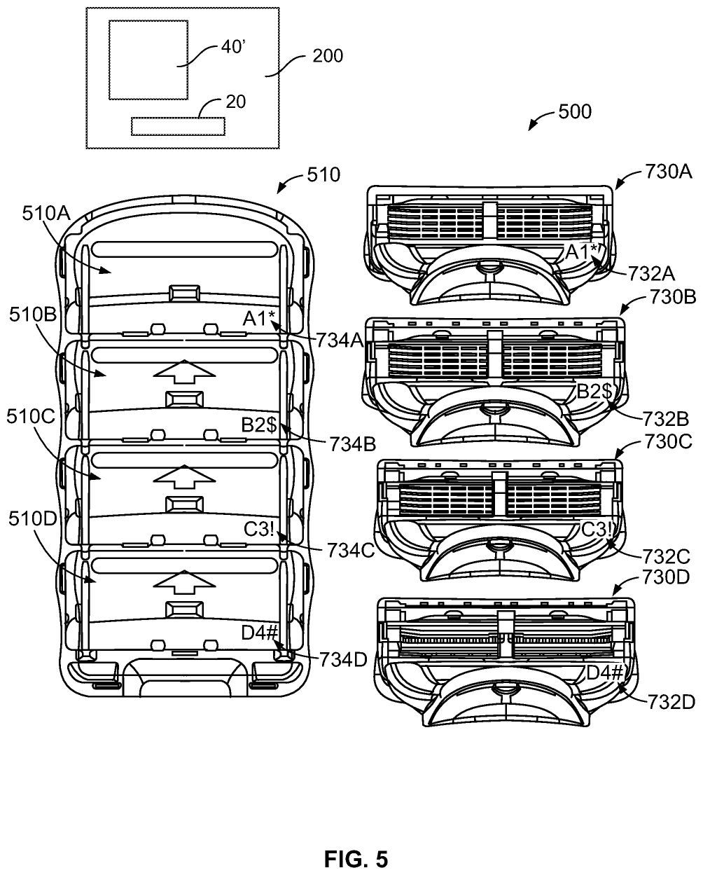

A consumer product trial kit 500 constructed in accordance with a fourth embodiment of the present disclosure is illustrated in FIG. 5. The trial kit 500 preferably includes a razor handle 20 and may comprise a container 200 and a selection recorder 40′, which are schematically illustrated in FIG. 5 and formed in the same manner as the handle 20, container 200 and selection recorder 40 of the embodiment illustrated in FIG. 1, wherein the selection recorder 40′ includes four selection windows. The trial kit 500 further comprises a first razor cartridge 730A, a second razor cartridge 730B, a third razor cartridge 730C, and a fourth razor cartridge 730D, wherein each of the first, second, third and fourth razor cartridges 730A-730D has one or more skin engaging features which are different from one or more skin engaging features on the other three cartridges.

The consumer product trial kit 500 may further comprise a tray 510 for releasably holding the first, second, third and fourth cartridges 730A-730D.

To allow the consumer to easily identify and differentiate each of the razor cartridges 730A-730D, each razor cartridge 730A-730D may comprise one or more identifying features associated with the razor cartridge, wherein the one or more identifying features may comprise at least one of a graphic, a symbol, a letter or a number integral with or coupled to the razor cartridge. The identifying features may comprise any combination of one or more graphics, symbols, letters and/or numbers. The identifying features may be formed or molded as part of the cartridge housing or may be printed on the cartridge housing. In the embodiment illustrated in FIG. 5, each of the first, second, third and fourth razor cartridges 730A-730D comprises an identifying feature defined by a symbol, a letter and a number integral with or coupled to the razor cartridge. More specifically, the first razor cartridge 730A comprises a first identifying feature 732A defined by the following first letter, first number and first symbol “A1*”; the second razor cartridge 730B comprises a second identifying feature 732B defined by the following second letter, second number and second symbol “B2S”; the third razor cartridge 730C comprises a third identifying feature 732C defined by the following third letter, third number and third symbol “C3 !”; and the fourth razor cartridge 730D comprises a fourth identifying feature 732D defined by the following fourth letter, fourth number and fourth symbol “D4 #”. Hence, the combination of the letters, numbers and symbols on each razor cartridge 730A-730D allows a consumer to easily distinguish the razor cartridges 730A-730D from one another.

Each of the first, second, third and fourth razor cartridges 730A-730D in the embodiment illustrated in FIG. 5 has a second identifying feature associated with the razor cartridge comprising at least one of a graphic, a symbol, a letter or a number integral with or coupled to the tray 510 adjacent to a compartment in the tray 510 where the razor cartridge is housed. The identifying features may comprise any combination of one or more graphics, symbols, letters and/or numbers. The identifying features may be formed or molded as part of the tray 510 or may be printed on the tray 510. In the embodiment illustrated in FIG. 5, each of the first, second, third and fourth compartments 510A, 510B, 510C and 510D of the tray 510 comprises an adjacent identifying feature defined by a symbol, a letter and a number integral with or coupled to the tray 510. More specifically, the first compartment 510A comprises a first identifying feature 734A defined by the following first letter, first number and first symbol “At*” located adjacent to the first compartment 510A; the second compartment 510B comprises a second identifying feature 734B defined by the following second letter, second number and second symbol “B2S” located adjacent to the second compartment 510B; the third compartment 510C comprises a third identifying feature 734C defined by the following third letter, third number and third symbol “C3!” located adjacent to the third compartment 510C; and the fourth compartment 510D comprises a fourth identifying feature 734D defined by the following fourth letter, fourth number and fourth symbol “D4 #” located adjacent to the fourth compartment 510D. The first, second, third and fourth identifying features 734A-734D on the tray 510 are preferably the same as the first, second, third and fourth identifying features 732A-732D on the razor cartridges 730A-730D. Hence, the combination of the letters, numbers and symbols adjacent each compartment 510A-510D further allows a consumer to easily distinguish the corresponding razor cartridges 730A-730D from one another.

Any of the identifying features provided in the embodiments of FIGS. 1-4 may be used with the identifying features 732A-732D and 734A-734D of the embodiment illustrated in FIG. 5.

The selection recorder 40′ of the trial kit 500 may comprise a tag list including a selection window corresponding to each of the first, second, third and fourth razor cartridges 730A-730D. The corresponding identifying feature 732A-732D for each of the razor cartridges 730A-730D may be printed inside or adjacent to each selection window. A consumer can indicate a selected one of the first, second, third or fourth cartridges 730A-730D by marking the corresponding window in the tag list for the selected one cartridge or punching the corresponding window in the tag list for the selected one cartridge.

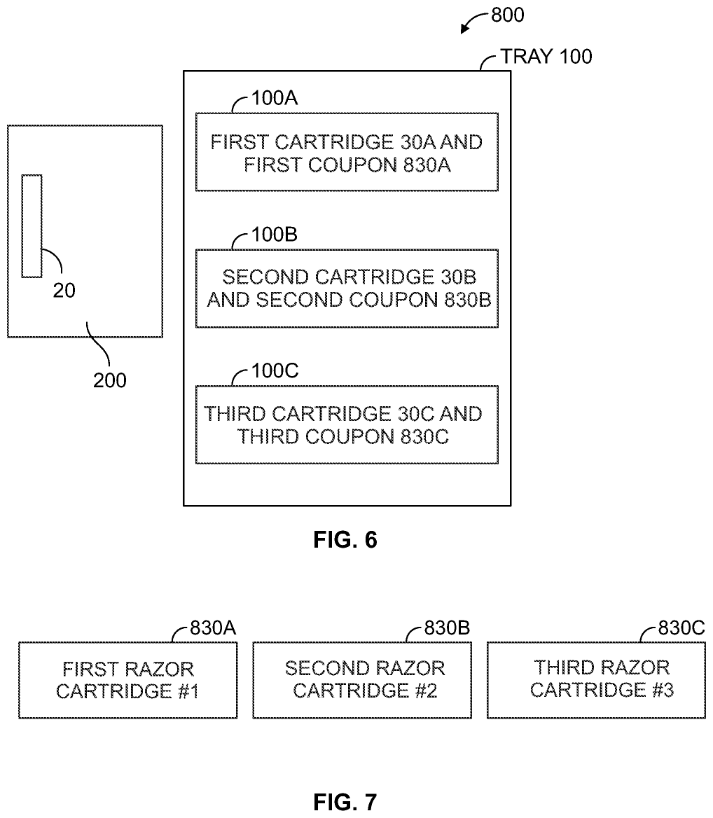

A consumer product trial kit 800 constructed in accordance with a fifth embodiment of the present disclosure is illustrated in FIGS. 6 and 7. The trial kit 800 preferably includes a razor handle 20 and may comprise a container 200, which are schematically illustrated in FIG. 5 and formed in the same manner as the handle 20 and container 200 illustrated in FIG. 1. In this embodiment, the trial kit 800 includes first, second and third razor cartridges 30A-30C and a tray 100, which are constructed in the same manner as the corresponding elements of the embodiment illustrated in FIGS. 1 and 2. However, the selection recorder in the embodiment of FIGS. 6 and 7 is defined by first, second and third coupons 830A-830C. Each coupon 830A-830C may be printed on paper, paperboard, cardboard or other like material and includes at least one of a graphic, a symbol, a letter and/or a number for identifying its corresponding razor cartridge 30A-30C. In the embodiment illustrated in FIG. 7, each coupon 830A-830C identifies its corresponding cartridge 30A-30C via a corresponding number. Each coupon 830A-830C may be stored in a tray compartment 100A-100C with its corresponding cartridge 30A-30C when received from the manufacturer or may be adhered to its corresponding cartridge 30A-30C.

After the consumer selects a desired cartridge, the consumer may submit the corresponding coupon 830A-830C to the manufacturer to order additional ones of the selected razor cartridge. The corresponding coupon 830A-830C may be mailed to the manufacturer or a photo of the corresponding coupon 830A-830C may be made, which photo may be sent to the manufacturer via email, text or mail.

Instead of sending the coupon corresponding to the selected razor cartridge directly to the manufacturer, the consumer may carry the coupon with her/him during a next trip to a store to purchase ones of the selected cartridge such that the coupon functions as a reminder to the consumer of the model/type of the cartridge she/he prefers. Because stores typically stock many different shaving razors and shaving razor cartridges, providing a consumer with a coupon identifying the cartridge she/he prefers that the consumer can easily carry with her/him during a next shopping trip makes shopping for additional razor cartridges much more efficient and reduces the likelihood that a consumer will purchase the wrong or not preferred razor cartridges.

The coupons 830A-830C may include a discount code (not shown) printed on the coupons which allows a consumer to receive a discount, e.g., a 10% discount, on the next purchase of a predefined number of razor cartridges. The discount code may be used online or in a store to obtain the discount. By providing a discount code on the coupon 830A-830C, the consumer is provided with an incentive to retain the coupon.

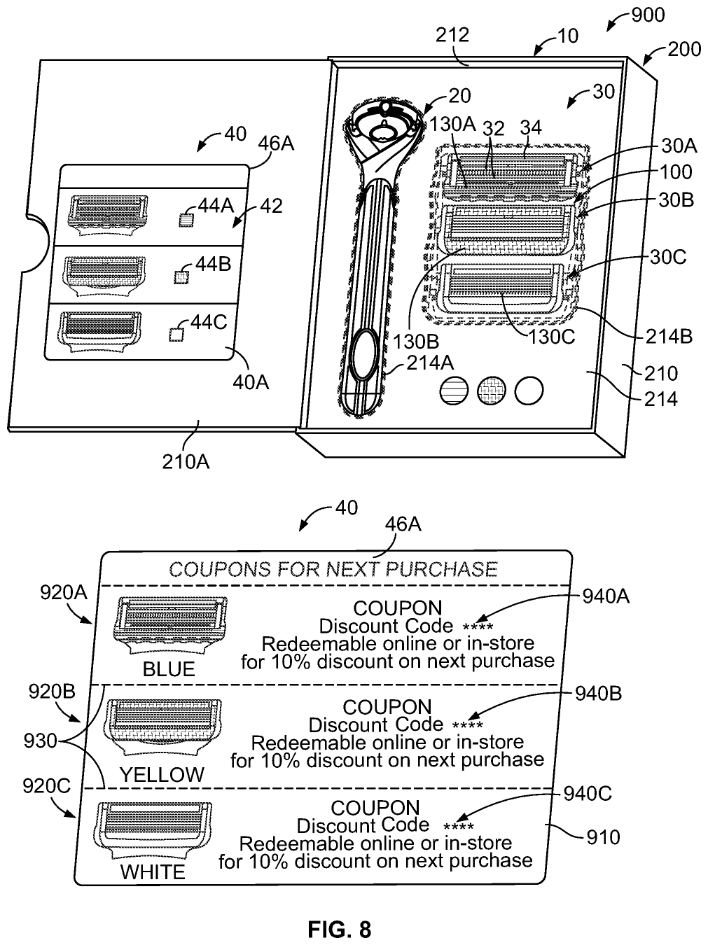

A consumer product trial kit 900 constructed in accordance with a sixth embodiment of the present disclosure is illustrated in FIG. 8. The trial kit 900 preferably includes a razor handle 20, first, second and third razor cartridges 30A-30C, a tray 100, a container 200 and a selection recorder 40, which are constructed in the same manner as the corresponding elements of the embodiment illustrated in FIGS. 1 and 2. The trial kit 900 further includes a sheet or card 910 including first, second and third coupons 920A-920C. Perforation lines 930 are provided between the coupons 920A-920C to allow for easy separation of the coupons from one another. The card 910 may be attached to the cover 210A or other portion of the box 200 via a perforation line or adhesive for easy detachment or may be a separate card that is loosely placed within the box 200.

In the embodiment illustrated in FIG. 8, the coupons 930A-930C may include a discount code 940A-940C printed on the coupons which allows a consumer to receive a discount, e.g., a 10% discount, on the next purchase of a predefined number of razor cartridges. The discount code may be used online or in a store to obtain the discount.

In the embodiment of FIG. 1, a coupon 46 is shown attached to the card 40 along a perforated line 46A. The coupon 46 can easily be removed from the card 40 via the perforation line 46A. The coupon includes a discount code 47 which may be used online or in a store to obtain the discount.

It is also contemplated that a coupon could be defined by a prepaid voucher or gift card, which prepaid voucher or gift card includes at least one selection window to allow a consumer to attach a label to the gift card, such as one of the labels 230A-230D attached to the tray 100 or one of the labels 630A-630D attached to the cartridges 430A-430D. The labels could serve as a reminder to the customer of her/his preferred cartridge. The prepaid voucher or gift card could be secured to or loosely provided within the box 200, such that a consumer could use the prepaid voucher or gift card to purchase ones of her/his preferred cartridges.

The illustrations presented herein are not intended to be actual views of any particular substrate, apparatus (e.g., device, system, etc.), or method, but are merely idealized and/or schematic representations that are employed to describe and illustrate various embodiments of the disclosure.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A consumer product trial kit comprising:
a razor handle;
a first razor cartridge configured to couple with the razor handle and comprising a first skin engaging feature;
a first identifying feature associated with the first razor cartridge;
a second razor cartridge configured to couple with the razor handle and comprising a second skin engaging feature;
a second identifying feature associated with the second razor cartridge;
wherein the second skin engaging feature and the associated second identifying feature are different than the first skin engaging feature and the associated first identifying feature, respectively; and
a selection recorder configured to allow selection of either the first razor cartridge or the second razor cartridge.

2. The consumer product trial kit of claim 1, wherein the associated first identifying feature comprises a first distinguishable feature formed as part of the first razor cartridge and the associated second identifying feature comprises a second distinguishable feature formed as part of the second razor cartridge.

3. The consumer product trial kit of claim 2, wherein the first distinguishable feature is defined by the first skin engaging feature of the first razor cartridge having a first distinguishable color and the second distinguishable feature is defined by the second skin engaging feature of the second razor cartridge having a second distinguishable color.

4. The consumer product trial kit of claim 1, wherein the associated first identifying feature comprises a first coupon associated with the first razor cartridge and the associated second identifying feature comprises a second coupon associated with the second razor cartridge.

5. The consumer product trial kit of claim 4, wherein the first and second coupons also define the selection recorder.

6. The consumer product trial kit of claim 4, further comprising a tray having a first compartment for receiving the first razor cartridge and a second compartment for receiving the second razor cartridge, wherein the first coupon is located in the first compartment with the first razor cartridge and the second coupon is located in the second compartment with the second razor cartridge.

7. The consumer product trial kit of claim 1, wherein the first identifying feature comprises at least one of a first graphic, a first symbol, a first letter or a first number integral with or coupled to the first razor cartridge and the second identifying feature comprises at least one of a second graphic, a second symbol, a second letter or a second number integral with or coupled to the second razor cartridge.

8. The consumer product trial kit of claim 1, wherein the associated first identifying feature comprises a first distinguishable feature removably attached to the first razor cartridge and the associated second identifying feature comprises a second distinguishable feature removably attached to the second razor cartridge.

9. The consumer product trial kit of claim 8, wherein the first removable feature comprises a first visually distinguishable label and the second removable feature comprises a second visually distinguishable label, the selection recorder comprises at least one selection window for receiving one of the first or the second label to record the selection of either the first or the second razor cartridge.

10. The consumer product trial kit of claim 1, further comprising a tray, wherein the first razor cartridge and the second razor cartridge are positioned within the tray.

11. The consumer product trial kit of claim 10, wherein the associated first identifying feature comprises a first distinguishable feature located on the tray proximate to the first razor cartridge and the associated second identifying feature comprises a second distinguishable feature located on the tray proximate to the second razor cartridge.

12. The consumer product trial kit of claim 11, wherein the first distinguishable feature comprises at least one of a first graphic, a first symbol, a first letter or a first number integral with or coupled to the tray and the second distinguishable feature comprises at least one of a second graphic, a second symbol, a second letter or a second number integral with or coupled to the tray.

13. The consumer product trial kit of claim 11, wherein the first distinguishable feature comprises a first distinguishable label removably attached to the tray proximate to the first razor cartridge and the second distinguishable feature comprises a second distinguishable label removably attached to the tray proximate to the second razor cartridge, the selection recorder comprises at least one selection window for receiving one of the first or the second label to record the selection of either the first or the second razor cartridge.

14. The consumer product trial kit of claim 1, wherein the selection recorder comprises a tag list including a selection window corresponding to each of the first and second razor cartridges.

15. The consumer product trial kit of claim 14, wherein a user can indicate a selected one of the first cartridge or the second cartridge by marking the corresponding window in the tag list for the selected one cartridge, punching the corresponding window in the tag list for the selected one cartridge or pasting a label in the corresponding window in the tag list for the selected one cartridge

16. The consumer product trial kit of claim 1, wherein the selection recorder comprises a selection window for receiving a label identifying a selected one of the first razor cartridge or the second razor cartridge.

17. The consumer product trial kit of claim 1, further comprising an instruction list to provide instructions for sampling the razor cartridges.

18. A consumer product trial kit comprising:
a razor handle;
a first razor cartridge configured to couple with the razor handle and comprising a first skin engaging feature;
a first identifying feature associated with the first razor cartridge;
a second razor cartridge configured to couple with the razor handle and comprising a second skin engaging feature;
a second identifying feature associated with the second razor cartridge;
wherein the second skin engaging feature and the associated second identifying feature are different than the first skin engaging feature and the associated first identifying feature, respectively;
a tray, wherein the first razor cartridge and the second razor cartridge are positioned within the tray; and
a selection recorder configured to allow selection of either the first razor cartridge or the second razor cartridge.

19. The consumer product trial kit according to claim 18, further comprising an instruction list to provide instructions for sampling the razor cartridges.
